(19) United States
(12) Patent Application Publication
(10) Pub. No.: US 2009/0213065 A1
(43) Pub. Date: Aug. 27, 2009

(54) ELECTROPHORETIC DISPLAY DEVICE AND ELECTRONIC APPARATUS

(75) Inventor: Takahiro Amano, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/389,567

(22) Filed: Feb. 20, 2009

(30) Foreign Application Priority Data
Feb. 25, 2008 (JP) 2008-042389

(51) Int. Cl. G09G 3/34

(52) U.S. Cl. 345/107

(57) ABSTRACT

An electrophoretic display device includes pixels planarly arranged and including electrophoretic devices. The electrophoretic devices each include a pixel electrode, an opposite electrode opposing the pixel electrode, and an electrophoretic layer disposed between the pixel electrode and the opposite electrode and including electrophoretic particles. The region between the pixel electrodes adjacent to each other is provided with an insulating layer including a hygroscopic insulating material.

### BACKGROUND

1. Technical Field

The present invention relates to an electrophoretic display device and an electronic apparatus.

2. Related Art

Electrophoretic display devices, which have electrophoretic dispersions each containing a liquid phase dispersing medium and electrophoretic particles and utilize a change in optical characteristics of the electrophoretic dispersion due to a change in distribution of the electrophoretic particles when an electric field is applied thereto, are known. The electrophoretic display devices do not require backlights and, therefore, can be reduced in cost and thickness. Furthermore, since the electrophoretic display devices achieve wide viewing angles and high contrast ratios and are also memory displays, they are expected as a next-generation display device.

In order to display an image with such an electrophoretic display device, an image signal is once stored in a memory circuit through a switching element. The image signal stored in the memory circuit is directly input into a pixel electrode (first electrode) to apply an electric potential to the pixel electrode, which causes an electric potential difference with an opposite electrode (second electrode). As a result, an electrophoretic device is driven to display an image (see, for example, JP-A-2003-84314).

In order to display an image with the electrophoretic display device, it is necessary to apply a voltage of, for example, about 15 V between the electrodes that hold electrophoretic particles therebetween. On this occasion, when colors that are different (inverted) from each other, such as black and white, are displayed in adjacent pixels, the pixel electrodes of the adjacent pixels are applied with different electric potentials. This generates a large difference in electric potential between the adjacent pixel electrodes, resulting in a flow of a leakage current between the adjacent pixel electrodes through moisture and other substances in an adhesive layer disposed on the pixel electrode.

Although the leakage current per pixel is small, the total leakage current over the entire display unit of the electrophoretic display device becomes large. This leads to an increase in power consumption. In addition, inverted display area is enlarged to complicate the display. This also leads to an increase in power consumption.

Furthermore, the leakage current may cause a chemical reaction in the pixel electrodes, resulting in a decrease in reliability of the electrophoretic display device, in particular, when the display device is used for a long time.

### SUMMARY

An advantage of some aspects of the invention is that it provides an electrophoretic display device in which a flow of a leakage current between pixels is suppressed to improve the reliability of a resulting product. Another advantage of some aspects of the invention is that it provides an electronic apparatus including the electrophoretic display device.

The electrophoretic display device of the invention includes a first pixel electrode, a second pixel electrode adjacent to the first pixel electrode, an opposite electrode opposing the first and the second pixel electrodes, and an electrophoretic layer disposed between the first and the second pixel electrodes and the opposite electrode. In the electrophoretic display device, the region between the first and the second pixel electrodes is provided with an insulating layer including a hygroscopic insulating material.

In the electrophoretic display device, the insulating layer disposed between the pixel electrodes blocks a flow of a leakage current, that is, a lateral electric field, between the adjacent pixel electrodes. Consequently, the occurrence of the leakage current between the pixels can be suppressed. The insulating layer is made of a hygroscopic insulating material. Therefore, for example, when an electrophoretic display device has an adhesive layer between the pixel electrodes and the electrophoretic layer, moisture contained in the adhesive layer is absorbed by the insulating layer and is thereby removed from the adhesive layer. Accordingly, the occurrence of a leakage current caused by moisture is prevented to suppress the leakage current itself. Consequently, a decrease in display performance and an increase in consumption current caused by leakage current are inhibited, resulting in an improvement in reliability of a resulting product.

The insulating layer of the electrophoretic display device is preferably disposed so as to be spaced from the first and the second pixel electrodes.

The insulating layer absorbs moisture, and, thereby, the insulation quality of the insulating layer may be locally decreased due to this absorbed moisture. However, since the insulating layer is spaced from the pixel electrodes, for example, an adhesive layer can be disposed between the adjacent pixel electrodes. Thus, the pixel electrodes do not adjoin to each other with only the insulating layer absorbing moisture therebetween. Consequently, the leakage current due to moisture absorbed by the insulating layer is reliably prevented from flowing between the adjacent pixel electrodes.

The insulating layer of the electrophoretic display device preferably projects toward the electrophoretic layer than the top faces of the first and the second pixel electrodes.

In such a structure, the leakage current has to cross over the upside of the insulating layer between the adjacent pixel electrodes. Therefore, the path of the leakage current becomes long (large), which prevents the leakage current from flowing between the pixel electrodes.

The electrophoretic layer of the electrophoretic display device preferably includes a microcapsule encapsulating electrophoretic particles and being disposed above the first and the second pixel electrodes via an electroconductive adhesive layer.

In such a structure, the electrophoretic particles are uniformly distributed in the electrophoretic layer, which allows displaying a uniform image based on the potential difference between the electrodes.

An electronic apparatus according to an aspect of the invention includes the electrophoretic display device.

Since the electronic apparatus is provided with the electrophoretic display device that is prevented from a decrease in display performance and an increase in power consumption caused by leakage current and is thereby improved in reliability, the electronic apparatus itself is satisfactorily improved in reliability.

### BRIEF DESCRIPTION OF THE DRAWINGS

The invention will be described with reference to the accompanying drawings, wherein like numbers reference like elements.

FIG. 1 is a configuration diagram of an electrophoretic display device.

FIG. 2 is a diagram illustrating a circuit configuration of a pixel.

FIG. 3 is a partial cross-sectional view of a display unit according to an embodiment of the invention.

FIG. 4 is a plan view of pixel electrodes and insulating layers.

FIG. 5 is a configuration diagram of a microcapsule.

FIG. 6A is a diagram illustrating a behavior of a microcapsule.

FIG. 6B is a diagram illustrating a behavior of a microcapsule.

FIG. 7A is a diagram illustrating a process for producing an electrophoretic display device.

FIG. 7B is a diagram illustrating the process for producing the electrophoretic display device.

FIG. 7C is a diagram illustrating the process for producing the electrophoretic display device.

FIG. 8 is a timing chart.

FIG. 9 is a schematic view of adjacent pixels.

FIG. 10 is a configuration diagram of an electrophoretic display device.

FIG. 11 is a circuit diagram of a pixel.

FIG. 12 is a diagram showing an example of the electronic apparatus according to the invention.

FIG. 13 is a diagram showing an example of the electronic apparatus according to the invention.

### DESCRIPTION OF EXEMPLARY EMBODIMENTS

The invention will now be described in detail with reference to the drawings. In these drawings, the scale of each component is suitably changed in to recognizable sizes.

Electrophoretic Display Device

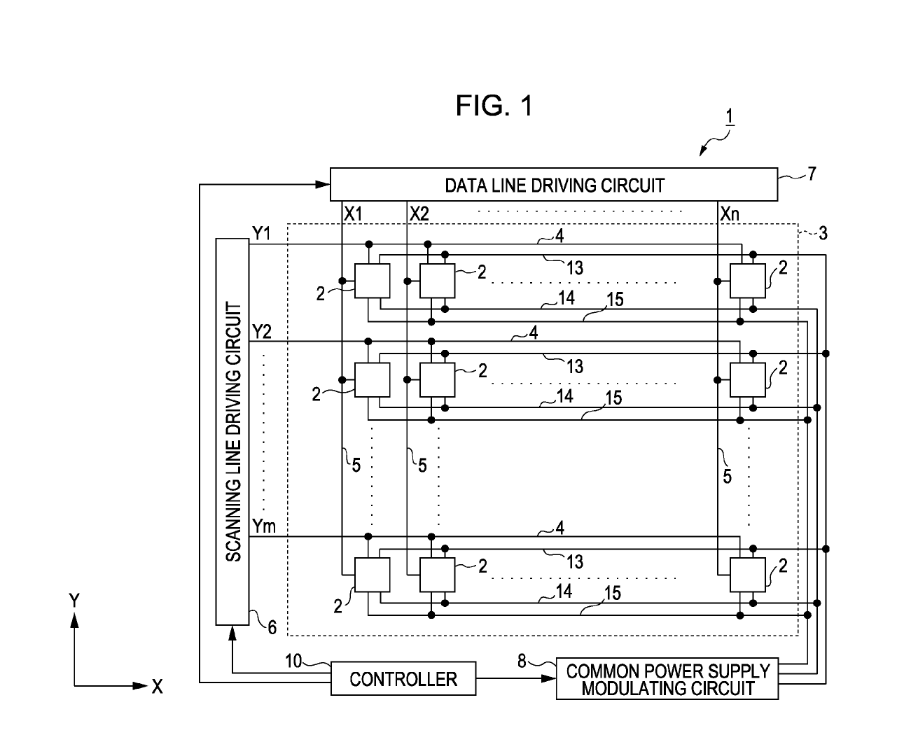

FIG. 1 is a configuration diagram illustrating an electrophoretic display device according to an aspect of the invention. The electrophoretic display device 1 shown in FIG. 1 includes a display unit 3, a scanning line-driving circuit 6, a data line-driving circuit 7, a common power supply-modulating circuit 8, and a controller 10.

In the display unit 3, pixels 2 are arranged in a matrix form having M pixels in the Y-axis direction and N pixels in the X-axis direction. The scanning line-driving circuit 6 is connected to the pixels 2 through a plurality of scanning lines 4 (Y1, Y2, . . . , and Ym) extending in the display unit 3 along the X-direction. The data line-driving circuit 7 is connected to the pixels 2 through a plurality of data lines 5 (X1, X2, . . . , and Xn) extending in the display unit 3 along the Y-direction. The common power supply-modulating circuit 8 is connected to the pixels 2 through common electrode power supplying wiring lines 15. The scanning line-driving circuit 6, the data line-driving circuit 7, and the common power supply-modulating circuit 8 are controlled by a controller 10. Power supplying lines 13 and 14 and the common electrode power supplying wiring lines 15 function as common wiring lines of all pixels 2.

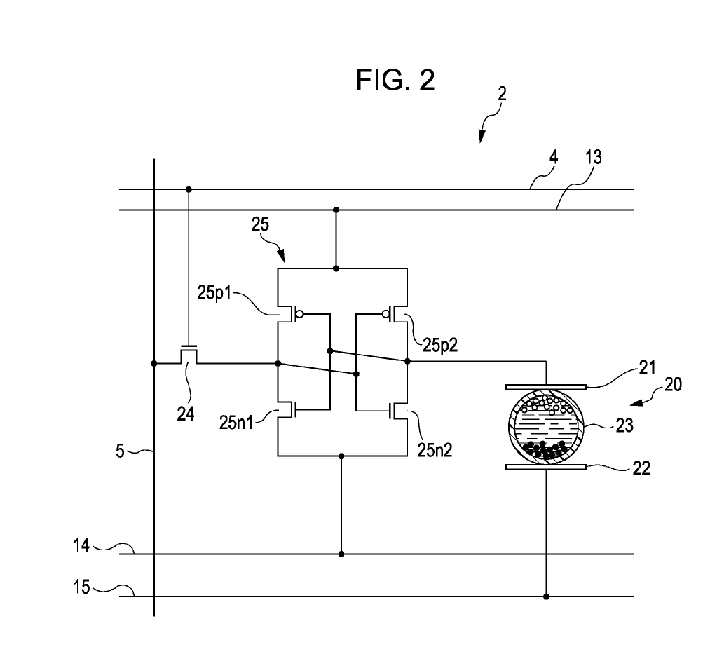

FIG. 2 is a diagram illustrating a circuit configuration of the pixel 2, which includes a driving TFT (thin film transistor, pixel switching element) 24, an SRAM (static random access memory, memory circuit) 25, and an electrophoretic device 20. The electrophoretic device 20 is composed of a pixel electrode 21, a common electrode (opposite electrode) 22, and an electrophoretic layer 23.

The driving TFT 24 is an N-MOS (negative metal oxide semiconductor) wherein the gate, source, and drain sides are connected to the scanning line 4, the data line 5, and the SRAM 25, respectively. During a period that a selection signal is input in the driving TFT 24 from the scanning line-driving circuit 6 through the scanning line 4, the data line 5 and the SRAM 25 are connected to each other, and an image signal is input to the SRAM 25 from the data line-driving circuit 7 through the data 5.

The SRAM 25 is composed of two P-MOSs (positive metal oxide semiconductors), 25p1 and 25p2, and two N-MOSs, 25n1 and 25n2. The source sides of the P-MOSs, 25p1 and 25p2, are connected to a first power supplying line 13, and the source sides of the N-MOSs, 25n1 and 25n2, are connected to a second power supplying line 14.

The drain sides of 25p1 of the P-MOS and 25n1 of the N-MOS of the SRAM 25 are connected to the driving TFT 24 and the gate portions of 25p2 of the P-MOS and 25n2 of the N-MOS, respectively. The drain sides of 25p2 of the P-MOS and 25n2 of the N-MOS of the SRAM 25 are connected to the gate portions of 25p1 of the P-MOS and 25n1 of the N-MOS, respectively.

With such a structure, the SRAM 25 retains an image signal sent from the driving TFT 24 and inputs an image signal to the pixel electrode 21.

The electrophoretic device 20 displays an image based on a potential difference between the pixel electrode 21 and the common electrode 22. The common electrode 22 is connected to the common electrode power supplying wiring line 15.

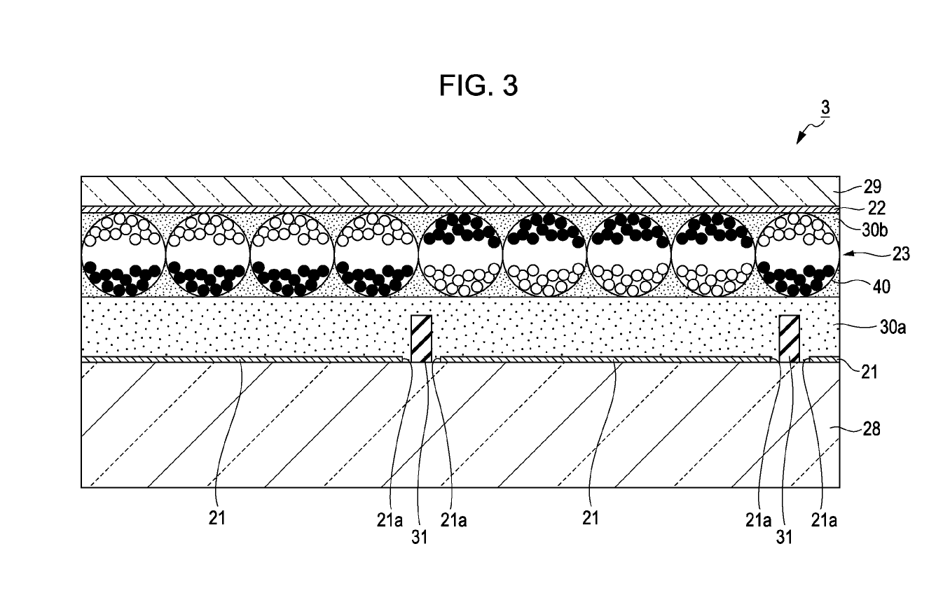

FIG. 3 is a cross-sectional view of the main portion of the display unit 3 of the electrophoretic display device 1. The display unit 3 includes an electrophoretic layer 23 between an elemental substrate (first substrate) 28 provided with pixel electrodes 21 and an opposite substrate (second substrate) 29 provided with a common electrode 22. The electrophoretic layer 23 includes a large number of microcapsules 40 that are fixed between the substrates 28 and 29 with an adhesive.

That is, an adhesive layer (electroconductive adhesive layer) 30a composed of an electroconductive adhesive material is disposed between the pixel electrodes 21 of the elemental substrate 28 and the electrophoretic layer 23, and a binder layer 30b composed of a binder (adhesive) is disposed between the common electrode 22 of the opposite substrate 29 and the electrophoretic layer 23. The adhesive layer 30a is imparted with sufficiently high electric conductivity for, as described blow, enhancing responsiveness of the electrophoretic particles in the microcapsules 40 and accelerating the switching rate of display. The adhesive layer 30a has a thickness of about 20 μm in this embodiment. Therefore, the resistance between the pixel electrodes 21 and the microcapsules 40 is sufficiently small to provide sufficiently high electric conductivity therebetween.

The elemental substrate 28 includes a rectangular substrate made of, for example, a synthetic resin or glass having an inner face provided with the driving TFTs 24, SRAMs 25, and various wiring lines, which are not shown, and a planarizing layer (not shown) of, for example, an acrylic resin covering the components such as the driving TFTs 24. Furthermore, the pixel electrodes 21 are disposed on the planarizing layer so as to be connected to the SRAMs 25. The pixel electrode 21 is independently provided to each pixel 2 and has a rectangular shape when planarly viewed. The pixel electrodes 21 are made of, for example, Al (aluminum), Cu (copper), or AlCu and are arranged in a matrix form. In this embodiment, the pixel electrodes 21 are made of AlCu, which has excellent electric conductivity and corrosion resistance.

The opposite substrate 29 is disposed at the side where images are displayed and is made of a light-transmissive material, such as a transparent resin or glass, in a rectangular shape. This opposite substrate 29 has an inner face provided with a common electrode 22 that commonly functions for all the pixels 2. The common electrode 22 is made of a light-transmissive electrically conductive material, such as ITO (indium tin oxide), IZO (indium zinc oxide), or MgAg (magnesium silver).

In a region between two pixel electrodes 21, i.e., between adjacent pixel electrodes 21, an insulating layer 31 is disposed. This insulating layer 31 is made of a hygroscopic insulating material, for example, an inorganic hygroscopic material such as calcium oxide, calcium chloride, diphosphorus pentoxide, aluminum oxide, cobalt chloride, or strontium oxide or an organic liquid desiccant containing alkyl aluminum as the main ingredient.

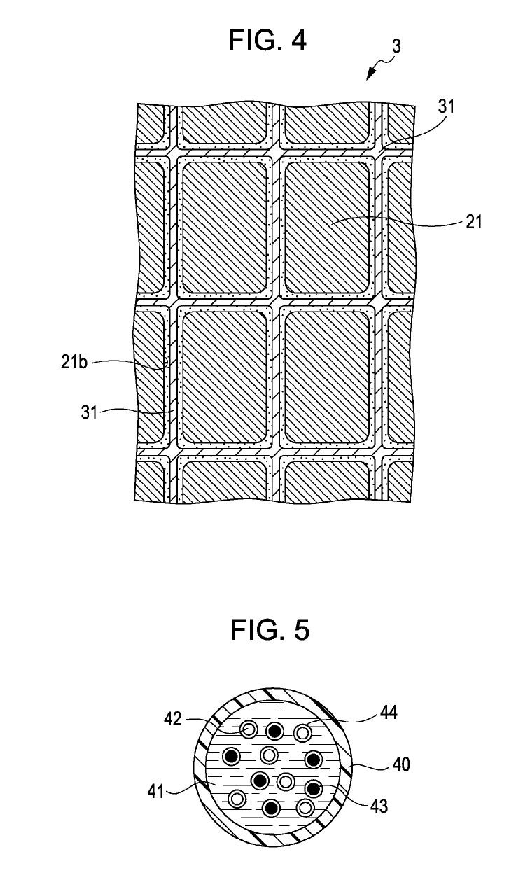

In this embodiment, this insulating layer 31 is disposed so as to be spaced from both the two pixel electrodes 21 adjacent to each other. In other words, the insulating layer 31 is disposed between the side end faces 21a of the adjacent pixel electrodes 21 not being in contact with the side end faces 21a. That is, as shown in FIG. 4, in a plan view illustrating the insulating layers 31 and the pixel electrodes 21, the insulating layers 31 are spaced from the pixel electrodes 21 and surround the pixel electrodes 21 in regions between the pixel electrodes 21 to form a grid pattern as a whole. In addition, as shown in FIG. 3, the top faces of the insulating layers 31 project toward the electrophoretic layer 23 than the top faces of the pixel electrodes 21.

The thickness of each insulating layer 31, that is, the height of the insulating layer 31 projecting toward the electrophoretic layer 23 than the top faces of the pixel electrodes 21, is preferably 1 μm or larger but not larger than the thickness of the adhesive layer 30a, i.e., about 20 μm or smaller. A thickness of smaller than 1 μm may provide insufficient effect for preventing a leakage current from flowing between the pixel electrodes 21 adjacent to each other.

A thickness of larger than the thickness of the adhesive layer 30a increases the stress of the insulating layer 31, which may cause delamination of films. Furthermore, the insulating layer 31 having a thickness larger than the thickness of the adhesive layer 30a protrudes into the electrophoretic layer 23 and may damage the microcapsules 40. However, the microcapsules 40 have considerable flexibility and, therefore, are not immediately damaged, even if the insulating layer 31 slightly protrudes into the electrophoretic layer 23. In this embodiment, the height of the insulating layer 31 protruding toward the electrophoretic layer 23 than the top faces of the pixel electrodes 21 is about 1.8 μm.

The insulating layer 31 is formed by an appropriate process depending on the hygroscopic insulating material. For example, in the case of an organic liquid desiccant containing alkyl aluminum as the main ingredient, the insulating layers 31 can be formed by placing the liquid desiccant between the pixel electrodes 21 by droplet-discharging such as ink jetting and then drying the applied liquid desiccant. Also in the case of an inorganic hygroscopic material such as calcium oxide, the insulating layer 31 can be formed by placing a solution or dispersion of the inorganic hygroscopic material at a desired region by droplet-discharging such as ink jetting and then drying the applied solution or dispersion.

In the inorganic hygroscopic material, the insulating layer 31 may be formed by forming a composite sheet of an inorganic hygroscopic material by fixing the material to a porous film, patterning the composite sheet, and pasting the patterned sheet at a desired position (between the pixel electrodes 21). Thus, an insulating layer 31 composed of an inorganic hygroscopic material fixed on a porous film can be formed. Such a sheet is commercially available.

In addition, the inorganic hygroscopic material can be formed into the insulating layer 31 by selectively forming a film at a desired position using a mask by electron beam (EB) evaporation.

The microcapsules 40 in the electrophoretic layer 23 are formed of a light-transmissive high molecular resin, for example, an acrylic resin such as methyl polymethacrylate or ethyl polymethacrylate, a urea resin, or gum arabic. The diameter of each microcapsule 40 is, for example, about 50 μm. The microcapsules 40 are held between the pixel electrode 21 and the common electrode 22, as described above. The microcapsules 40 are fixed to the pixel electrodes 21 and the common electrode 22, i.e., the elemental substrate 28 and the opposite substrate 29, with the adhesive layer 30a and the binder layer 30b. In one pixel 2, a plurality of the microcapsules 40 are arranged lengthwise and crosswise, and a binder fills gaps among the microcapsules 40 to form the binder layer 30b.

As shown in FIG. 5, a dispersion medium 41 and a large number of electrophoretic particles, i.e., white particles 42 and black particles 43, are encapsulated within each microcapsule 40.

Examples of the dispersion medium 41 include water; alcohols such as methanol, ethanol, isopropanol, butanol, octanol, and methyl cellosolve; esters such as ethyl acetate and butyl acetate; ketones such as acetone, methylethylketone, and methylisobutylketone; aliphatic hydrocarbons such as pentane, hexane, and octane; alicyclic hydrocarbons such as cyclohexane and methylcyclohexane; aromatic hydrocarbons such as benzene, toluene, xylene, and benzenes having long-chain alkyl groups such as hexylbenzene, hebutylbenzene, octylbenzene, nonylbenzene, decylbenzene, undecylbenzene, dodecylbenzene, tridecylbenzene, and tetradecylbenzene; halogenated hydrocarbons such as methylene chloride, chloroform, carbon tetrachloride, and 1,2-dichloroethane; carboxylates; various oils, and mixtures thereof in which a surfactant is added. The dispersion medium 41 is used to disperse the white particles 42 and the black particles 43 in the microcapsules 40. The dispersion medium 41 is used for dispersing the white particles 42 and the black particles 43 in the microcapsule 40.

The white particles 42 are, for example, negatively charged particles (macromolecules or colloids) formed of a white pigment such as titanium dioxide, zinc oxide, or antimony trioxide. The black particles 43 are, for example, positively charged particles (macromolecules or colloids) formed of a black pigment such as aniline black or carbon black.

The pigment may be optionally added with an electrolyte, a surfactant, a metal soap, a resin, rubber, an oil, a varnish, a charge controller including compound particles, a dispersant such as a titanium coupling agent, an aluminum coupling agent, or a silane coupling agent, a lubricant, or a stabilizer.

The specific gravities of these electrophoretic particles (white particles 42 and black particles 43) are adjusted so as to be approximately the same as that of the dispersion medium 41 dispersing the particles.

Since the white particles 42 and the black particles 43 are charged negatively or positively, as described above, they move (migrate) in the dispersion medium 41 according to the electric field generated by a potential difference between the pixel electrode 21 and the common electrode 22. The white particles 42 and the black particles 43 are coated with ions in the medium, which form ion layers 44 on the surfaces of the particles. In general, when an electric field having a frequency of 10 kHz or more is applied to charged particles, such as the white particles 42 and black particles 43, the charged particles hardly react to the electric field and therefore hardly move. However, since the ions surrounding the charged particles have diameters considerably smaller than those of the charged particles, when an electric field having a frequency of 10 kHz or more is applied to the ions surrounding the charged particles, the ions move in accordance with the electric field.

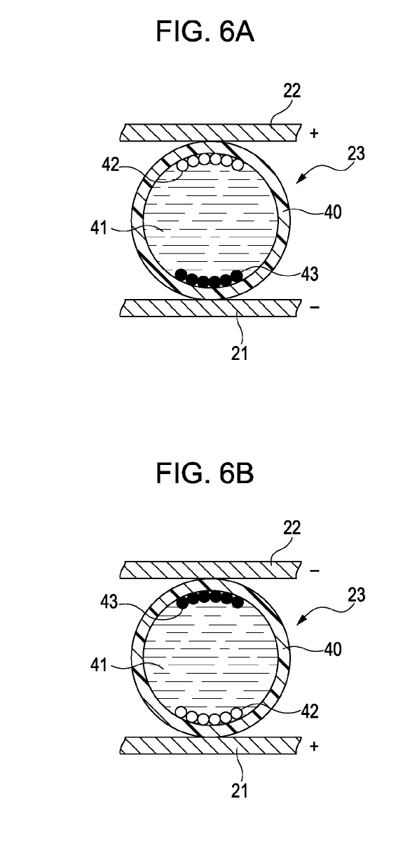

FIGS. 6A and 6B are diagrams illustrating behavior of the electrophoretic particles in the microcapsule 40. Here, an ideal case where the ion layer 44 is not formed will be described as an example. When a voltage is applied between the pixel electrode 21 and the common electrode 22 such that the electric potential of the common electrode 22 is relatively higher than that of the pixel electrodes 21, as shown in FIG. 6A, the black particles 43 that are positively charged are attracted toward the pixel electrode 21 by the Coulomb force in the microcapsule 40. On the other hand, the white particles 42 that are negatively charged are attracted toward the common electrode 22 by the Coulomb force in the microcapsule 40. As a result, the white particles 42 gather at the display surface side (opposite substrate 29 side) in the microcapsule 40, and color (white) of the white particles 42 is displayed on the display surface.

In contrary, when a voltage is applied between the pixel electrode 21 and the common electrode 22 such that the electric potential of the pixel electrode 21 is relatively higher than that of the common electrodes 22, as shown in FIG. 6B, the white particles 42 that are negatively charged are attracted toward the pixel electrode 21 by the Coulomb force. On the other hand, the black particles 43 that are positively charged are attracted toward the common electrode 22 by the Coulomb force. As a result, the black particles 43 gather at the display surface side in the microcapsule 40, and color (black) of the black particles 43 is displayed on the display surface.

The electrophoretic display device 1 can display a color such as red, green, or blue by changing the pigments used for the white particles 42 and the black particles 43 to pigments of red, green, or blue.

The electrophoretic display device 1 having such a configuration can be produced by forming an elemental substrate 28 portion and an opposite substrate 29 portion and then pasting the elemental substrate 28 portion and the opposite substrate 29 portion so as to hold an electrophoretic layer 23 therebetween, as shown in FIG. 3.

That is, the elemental substrate 28 portion is formed by forming the above-described driving TFTs 24, SRAMs 25, and various wiring lines on a substrate (not shown) by known processes and further forming a planarizing layer (not shown) made of, for example, an acrylic resin thereon. In the formation of the driving TFTs 24 and the SRAMs 25, it is preferable to form polysilicon TFTs by a low temperature polysilicon process.

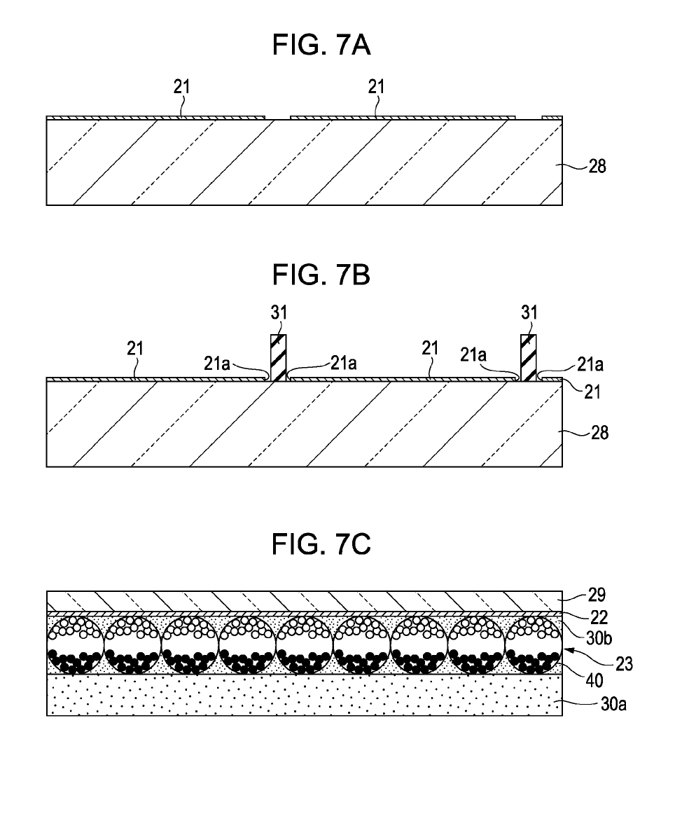

Then, an AlCu film (not shown) is formed on the elemental substrate 28 by sputtering, and the film is patterned by known technologies such as a resist technology and an etching technology into a large number of pixel electrodes 21, as shown in FIG. 7A, to give an active matrix substrate.

Then, a hygroscopic insulating material is selectively placed at predetermined positions on the elemental substrate 28, that is, a region between the pixel electrodes 21, to give insulating layers 31 as shown in FIG. 7B. The insulating layers 31 are formed by an appropriate process depending on the hygroscopic insulating material, as described above. That is, the insulating layers 31 may be formed by droplet-discharging such as ink jetting, pasting of a previously patterned sheet, or electron beam (EB) evaporation.

The opposite substrate 29 portion is formed by forming a common electrode 22 on a surface (inner face) of an opposite substrate 29 of a transparent substrate made of, for example, PET (polyethylene terephthalate) by sputtering a transparent electrically conductive material such as ITO. Then, microcapsules 40 are fixed above the common electrode 22 with a binder layer 30b to give an electrophoretic layer 23. Then, an adhesive layer 30a is formed on the inner face of the electrophoretic layer 23 by applying an electroconductive adhesive on the electrophoretic layer 23. In this embodiment, the adhesive layer 30a has a thickness of about 20 μm. Accordingly, as shown in FIG. 7C, an opposite substrate 29 having a common electrode 22, an electrophoretic layer 23, and an adhesive layer 30a is provided.

The thus prepared elemental substrate 28 portion and the opposite substrate 29 portion are put together by bonding the adhesive layer 30a with the pixel electrode 21 and the insulating layer 31. As a result, as shown in FIG. 3, the elemental substrate 28 portion and the opposite substrate 29 portion are bonded with the adhesive layer 30a to give an electrophoretic display device 1. The adhesive layer 30a of the electrophoretic display device 1 contains moisture that remains in the adhesive itself in a small amount and is contained in the adhesive layer 30a during the production process or migrated from the air or other components to the adhesive layer 30a after the production process.

### Driving Method of Electrophoretic Display Device

The driving method of the electrophoretic display device 1 according to the embodiment will now be described.

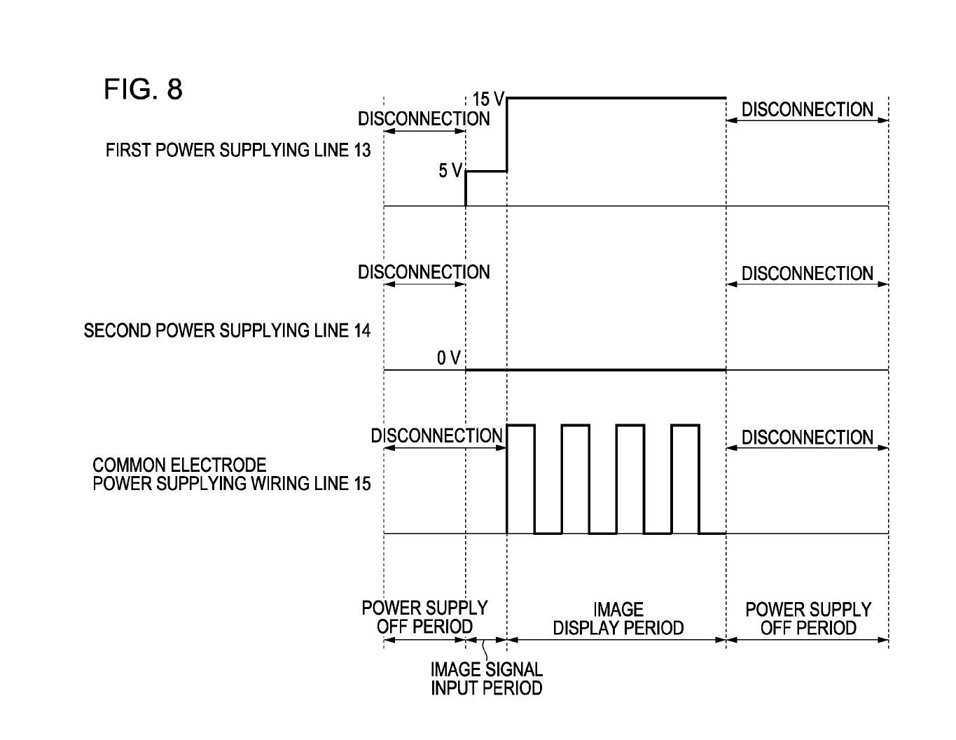

FIG. 8 is a timing chart of the electrophoretic display device 1 according to an aspect of the invention. This chart shows operation for displaying an image by driving the electrophoretic display device 1 in the order of a power supply off period, an image signal input period, an image display period, and a power supply off period. The following table shows the operation.

TABLE 1

| | | State of power supplying line | | | |
|---|---|---|---|---|---|
| | | First power supplying line | Second power supplying line | State of common | |
| Sequence | Operation purpose | 13 | 14 | electrode 22 | Image display |
| 1 | power supply off period | disconnection | disconnection | disconnection | previous image |
| 2 | image signal input period | 5 V | 0 V | disconnection | no change |
| 3 | image display period | high potential (15 V) | low potential (0 V) | pulse | new image |
| 4 | power supply off period | disconnection | disconnection | disconnection | new image |

First, the image signal input period will be described. The common power supply-modulating circuit 8 shown in FIG. 1 applies an electric potential of about 5 V to the first power supplying line 13 and a low electric potential of about 0 V to the second power supplying line 14 for driving the SRAM 25 shown in FIG. 2.

The scanning line-driving circuit 6 shown in FIG. 1 supplies a selection signal to a scanning line Y1. The driving TFTs 24 of the pixels 2 connected to the scanning line Y1 are driven by the scanning signal, and the SRAMs 25 of the pixels 2 connected to the scanning line Y1 are connected to the respective data lines X1, X2, . . . , Xn.

The data line-driving circuit 7 shown in FIG. 1 supplies image signals to the data lines X1, X2, . . . , Xn to give the image signals to the SRAMs 25 of the pixels 2 connected to the scanning line Y1.

The input of the image signals allows the scanning line-driving circuit 6 to discontinue the supply of the selection signal to the scanning line Y1 to release the pixels 2 connected to the scanning line Y1 from the selection state. This operation is continued until that the pixels 2 connected to the scanning line Ym are operated to input image signals to the SRAMs 25 of all pixels 2.

The image display period will now be described.

Subsequently, the common power supply-modulating circuit 8 supplies a high electric potential of about 15 V to the first power supplying lines 13 for the transition to an image display period.

The image signals input to the SRAMs 25 at 5 V are retained at a high potential when the SRAMs 25 are driven with a high electric potential.

A pulse signal that repeats a high potential period and a low potential period at a constant cycle is input to the common electrodes 22 from the common power supply-modulating circuit 8 via common electrode power supplying lines 15.

In a pixel 2 of which SRAM 25 receives a low potential image signal, a high potential is input to the pixel electrode 21 from the SRAM 25.

Consequently, a large potential difference is generated between the pixel electrode 21 and the common electrode 22 when the common electrode 22 receives the low potential of the pulse signal. Therefore, the white particles 42 are attracted to the pixel electrode 21, and the black particles 43 are attracted to the common electrode 22, and thereby this pixel 2 displays black color.

On the other hand, in a pixel 2 of which SRAM 25 receives an image signal of an electric potential of 5 V, a low potential is input to the pixel electrodes 21 from the SRAM 25.

Consequently, a large potential difference is generated between the pixel electrodes 21 and the common electrode 22 when the common electrode 22 receives the high potential of the pulse signal. Therefore, the black particles 43 are attracted to the pixel electrodes 21, and the white particles 42 are attracted to the common electrode 22, and thereby the pixel 2 displays white color.

An image is displayed during the image display period, and then the common power supply-modulating circuit 8 is electrically disconnected from the power supplying lines 13 and 14 and the common electrode power supplying lines 15 for the transition to a power supply off period.

### Suppression of Leakage Current

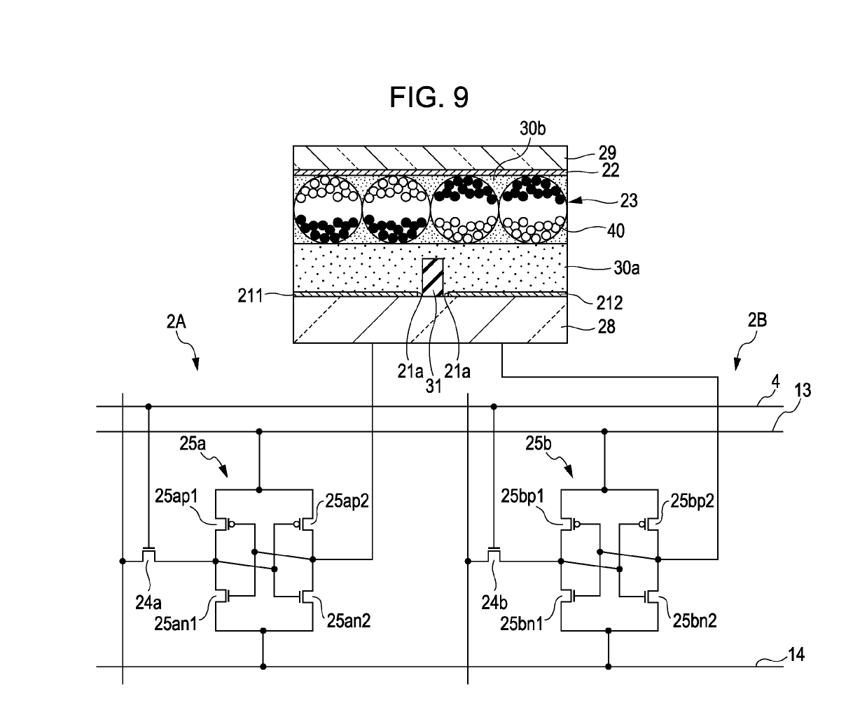

FIG. 9 is a schematic view of pixels 2 (2A and 2B) adjacent to each other of the display unit 3 shown in FIG. 1. The pixel 2A shown in the left side of the drawing includes a driving TFT 24a, an SRAM 25a, and a pixel electrode 211. The pixel 2B shown in the right side of the drawing includes a driving TFT 24b, an SRAM 25b, and a pixel electrode 212. Furthermore, an insulating layer 31 is disposed between the pixel electrodes 211 and 212.

The SRAM 25a is composed of P-MOSs, 25ap1 and 25ap2, and N-MOSS, 25an1 and 25an2, and the SRAM 25b is composed of P-MOSs, 25bp1 and 25bp2, and N-MOSS, 25bn1 and 25bn2.

The adjacent pixel electrodes 21 are applied with different electric potentials. For example, a high potential is applied to the pixel electrode 211, and a low potential is applied to the pixel electrode 212. Therefore, the pixel 2A displays black color, and the pixel 2B displays white color.

On this occasion, since a large electric field is generated between the pixel electrodes 211 and 212 due to the large potential difference, a leakage current readily flows through the adhesive layer 30a.

Since known electrophoretic display devices do not have insulating layers 31 shown in FIG. 3 between pixel electrodes 21, the path of the leakage current cannot be blocked. Therefore, a leakage current is generated by an electric field in the horizontal direction between the pixel electrodes. Such a leakage current is more readily generated because of the electrical conductivity enhanced by the moisture present in the adhesive layer 30a, as described above.

On the contrary, according to an aspect of the invention, the path for a leakage current between the adjacent pixel electrodes 21(211) and 21(212), i.e., the electric field in the horizontal direction, is blocked by the insulating layer 31. Therefore, the leakage current is sufficiently prevented from flowing. That is, since the insulating layer 31 is disposed between the pixel electrodes 21(211) and 21(212), the leakage current from a side end 21b of the pixel electrode 21 can be blocked, and therefore the leakage current can be more sufficiently prevented from flowing. Furthermore, since the top face of the insulating layer 31 projects toward the electrophoretic layer 23 than the top face of the pixel electrode 21, the leakage current has to over the top of the insulating layer 31. Therefore, the path of the leakage current becomes long (large), which prevents the leakage current from flowing between the adjacent pixel electrodes 21.

In addition, since the insulating layer 31 is made of a hygroscopic insulating material, the moisture present in the adhesive layer 30a adheres to (absorbed by) the insulating layer 31. Consequently, the amount of the moisture present in the adhesive layer 30a can be decreased. As a result, the occurrence of a leakage current that is accelerated by enhanced electric conductivity of the adhesive layer 30a by the moisture can be prevented, resulting in a suppression of leakage current itself.

In addition, since the insulating layer 31 is spaced from the pixel electrodes 21, the adhesive layer 30a is disposed between the adjacent pixel electrodes 21. Therefore, even if the insulation quality of the insulating layer 31 is locally decreased by the absorbed moisture, the pixel electrodes 21 do not adjoin to each other with only the moisture-absorbed insulating layer therebetween, and a leakage current due to the moisture absorbed by the insulating layer 31 is reliably prevented from flowing between the adjacent pixel electrodes 21(211) and 21(212).

In the resulting electrophoretic display device 1, a decrease in display performance and an increase in consumption current due to the leakage current are avoided, resulting in an improvement of reliability of a resulting product.

### Modification Example

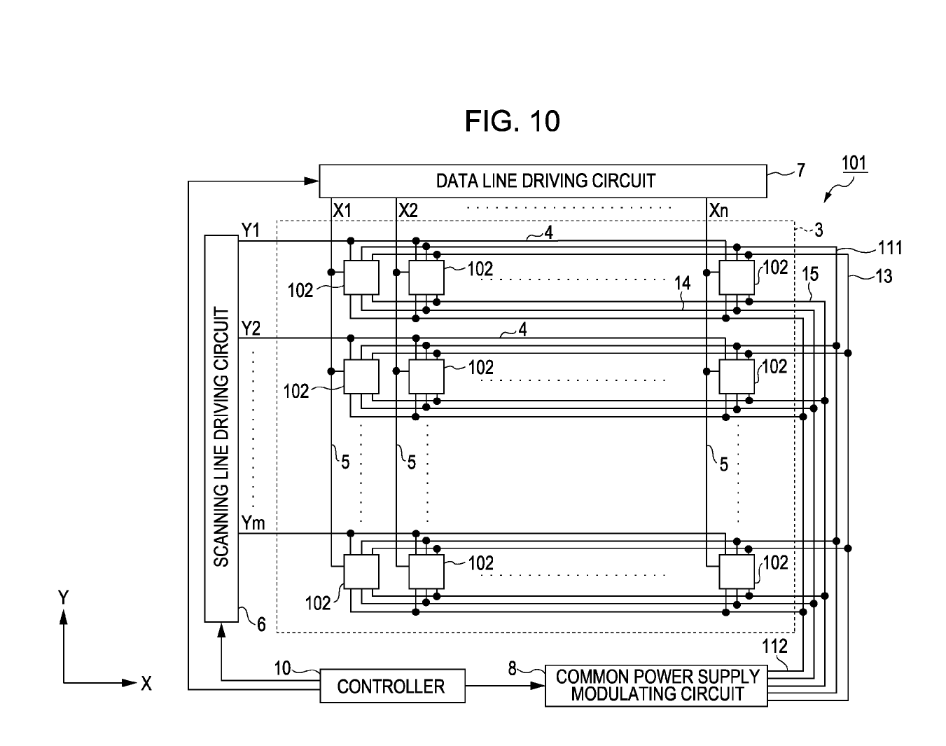

FIG. 10 is a configuration diagram of the electrophoretic display device 101 according to an aspect of the invention. The circuit configuration of this electrophoretic display device 101 is different from that of the electrophoretic display device 1 in that the common power supply-modulating circuit 108 is connected to pixels 102 via a first controlling line 111 and a second controlling line 112.

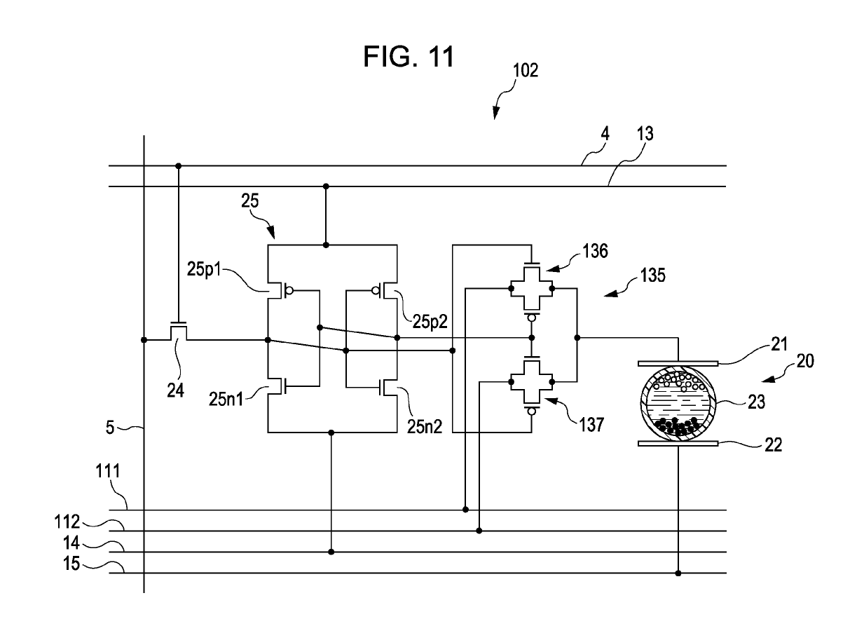

FIG. 11 is a circuit diagram of a pixel 102. The pixel 102 includes a switching circuit 135 disposed between an SRAM 25 and a first electrode 21. The switching circuit 135 includes a first transfer gate 136 and a second transfer gate 137. The transfer gates 136 and 137 are composed of a P-MOS and an N-MOS connected in parallel.

The gate portions of the transfer gates 136 and 137 are connected to the SRAM 25. The source side of the first transfer gate 136 is connected to the first controlling line 111. The source side of the second transfer gate 137 is connected to the second controlling line 112. The drain sides of the transfer gates 136 and 137 are connected to the pixel electrode 21.

In the electrophoretic display device 101 shown in FIG. 10, any one of transfer gates is driven based on an image signal input in the SRAM 125. The controlling line connected to the driven transfer gate is connected to a pixel electrode 21, and the electric potential of this controlling line is input in the pixel electrode 21. As a result, the pixel 102 displays an image.

Also in the electrophoretic display device 101 having a circuit configuration shown in FIG. 11, when different potentials are input to pixels 102 adjacent to each other, an electric field is generated due to the potential difference. However, the leakage current can be prevented from flowing by the insulating layer 31 disposed between the pixel electrodes 21, as shown in FIG. 3.

The present invention is not limited to the above-described embodiments and can be variously modified without departing from the spirit of the invention. For example, the insulating layer 31 may be in contact with the side end of the pixel electrode 21 or may lap over the periphery of the pixel electrode 21, as long as it is disposed between the adjacent pixel electrodes 21.

### Electronic Apparatus

The electronic apparatus according to an aspect of the invention includes the electrophoretic display device 1.

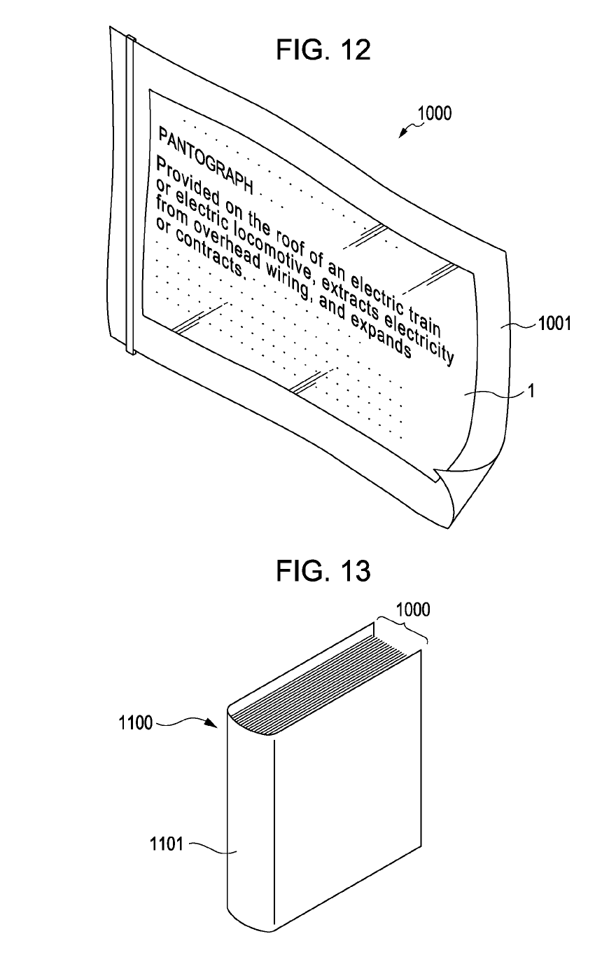

FIG. 12 is a diagram showing a flexible electronic paper as an example of the electronic apparatus according to an aspect of the invention. This electronic paper 1000 includes a body 1001 of a sheet having a texture and a flexibility similar to those of common paper and a display unit of the electrophoresis display device 1 disposed on the surface of the body 1001.

FIG. 13 is a diagram showing an electronic notebook as an example of the electronic apparatus according to an aspect of the invention. This electronic notebook 1100 includes a plurality of the electronic papers 1000 shown in FIG. 12 that are bundled with a cover 1101. The cover 1101 is provided with, for example, a display data input unit (not shown) for inputting display data from an external apparatus. This allows changing or updating the display content according to the display data, in the state that the electronic papers 1000 are bundled.

Since the electronic paper 1000 and the electronic notebook 1100 each include the electrophoretic display device 1 that is prevented from a decrease in display performance and an increase in consumption current due to leakage current and therefore is improved in reliability, the electronic paper 1000 and the electronic notebook 110 themselves are also improved in the reliability.

In addition to the above examples, liquid crystal televisions, video tape recorders having a viewfinder or a direct monitor view, car navigation systems, pagers, electronic schedulers, calculators, word processors, work stations, television telephones, POS terminals, and apparatuses having touch panels, which include the electrophoretic display device 1 as the display unit, are the electronic apparatuses of the present invention.

What is claimed is:

1. An electrophoretic display device comprising:
a first pixel electrode;
a second pixel electrode adjacent to the first pixel electrode;
an opposite electrode opposing the first and the second pixel electrodes;
an electrophoretic layer disposed between the first and the second pixel electrodes and the opposite electrode, and
an insulating layer including a hygroscopic insulating material disposed between the first and the second pixel electrodes.

2. The electrophoretic display device according to claim 1, wherein the insulating layer is spaced from the first and the second pixel electrodes.

3. The electrophoretic display device according to claim 1, wherein the insulating layer projects toward the electrophoretic layer than the top faces of the first and the second pixel electrodes.

4. The electrophoretic display device according to claim 1, wherein the electrophoretic layer includes a microcapsule encapsulating electrophoretic particles and being disposed above the first and the second pixel electrodes via an electroconductive adhesive layer.

5. An electronic apparatus comprising the electrophoretic display device according to claim 1.
